(19) United States
(12) Patent Application Publication
(10) Pub. No.: US 2021/0227169 A1
(43) Pub. Date: Jul. 22, 2021

(54) SYSTEM AND METHOD FOR USING PREDICTIVE ANALYSIS TO GENERATE A HIERARCHICAL GRAPHICAL LAYOUT

(71) Applicant: VONAGE BUSINESS INC., Atlanta, GA (US)

(72) Inventors: Yuval Golan, Rishon Le-zion (IL); Eyal Zach, Tel Aviv (IL)

(21) Appl. No.: 16/749,018

(22) Filed: Jan. 22, 2020

(51) Int. Cl. H04N 5/445; H04N 7/15

(52) U.S. Cl. CPC H04N 5/44591; H04N 7/15

(57) ABSTRACT

Methods and systems for using predictive analysis to generate a hierarchical layout of participants in a video conference on display devices are provided herein. In some embodiments, a method for using predictive analysis to generate a hierarchical layout of participants in a video conference on display devices comprises receiving a request to set up a video conference among three or more participants predicting, based on historical data, a dominant participant of the three or more participants in the video conference; and displaying a hierarchical layout of the participants on display devices of the two or more remaining subordinate speakers, who are not predicted to be the dominant speaker, with the predicted dominant participant displayed more prominently than the remaining three or more participants.

### BACKGROUND

### Field

Embodiments of the present invention generally relate to video conferencing, and more specifically, to a method and system for using predictive analysis to generate a hierarchical graphical layout of participants in a video conferencing session.

### Description of the Related Art

Oftentimes during a video conferencing call involving multiple participants, the participants are displayed on each user device display in an illogical order. For example, a participant who has little to contribute to the video conference may be displayed first, while a participant displayed in the middle or end of the group of participants may have a more active role in the call. This makes participants search for a current speaker on the display, leading to a poor user experience.

Therefore, there is a need in the art for using predictive analysis to generate a hierarchical graphical layout during a video conferencing session.

### SUMMARY

In some embodiments, a method for using predictive analysis to generate a hierarchical graphical layout during a video conferencing session includes receiving a request to set up a video conference among three or more participants; predicting, based on historical data, a dominant speaker of the three or more participants in the video conference; and displaying a hierarchical layout of the participants on display devices of the three or more participants with the predicted dominant speaker displayed more prominently than the remaining three or more participants

In some embodiments, a system for using predictive analysis to generate a hierarchical graphical layout during a video conferencing session includes at least one storage device storing processor-executable instructions which, when executed by the at least one processor, perform the method for using predictive analysis to generate a hierarchical graphical layout during a video conferencing session.

In some embodiments, a computer readable medium for storing computer instructions that, when executed by at least one processor causes the at least one processor to perform the method for using predictive analysis to generate a hierarchical graphical layout during a video conferencing session.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for using predictive analysis to generate a hierarchical graphical layout during a video conferencing session, according to one or more embodiments of the present invention;

FIG. 3 depicts a flow diagram of a method for using predictive analysis to generate a hierarchical graphical layout during a video conferencing session, in accordance with one or more embodiments of the present invention; and

FIG. 4 is an exemplary diagram of a computer system for using predictive analysis to generate a hierarchical graphical layout during a video conferencing session, in accordance with one or more embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and system for using predictive analysis to generate a hierarchical graphical layout during a video conferencing session. When a video conference involving three or more participants is to begin, historical data regarding the three or more participants in analyzed in order to predict which of the participants is likely to be the dominant speaker in the conference call. Historical data includes at least determining which of the three or more participants spoke most in previous interactions, specifically prior voice or video communications. Additional considerations in determining the dominant speaker include which participant organized the conference call, the topic of the conference call, the title or position of each participant, the subject matter expertise of each participant as it relates to the topic of the call, a geographic location, and/or an office or branch location of the participant, and the like. The three or more participants are ranked based on who is predicted to be the dominant speaker, who is predicted to be the second most dominant speaker, who is predicted to be third most dominant speaker, and so on. As used herein, the participants who are not predicted to be the dominant speaker are referred to as subordinate speakers. The predicted dominant speaker is displayed in a conference call display area more prominently than the subordinate speakers on the display devices of the subordinate speakers. The subordinate speakers are displayed on the display device of the dominant speaker. In some embodiments, the subordinate speakers are displayed on the display device of the dominant speaker with the predicted second most dominant speaker displayed more prominently than the remaining subordinate speakers. In some embodiments, the display of the participants is adjusted if the talk time of the predicted dominant speaker drops below a predefined threshold. In some embodiments, additional bandwidth is provided to the display device of the predicted dominant speaker. In some embodiments, the total bandwidth may be divided among the display devices of a predefined number of predicted top speakers.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

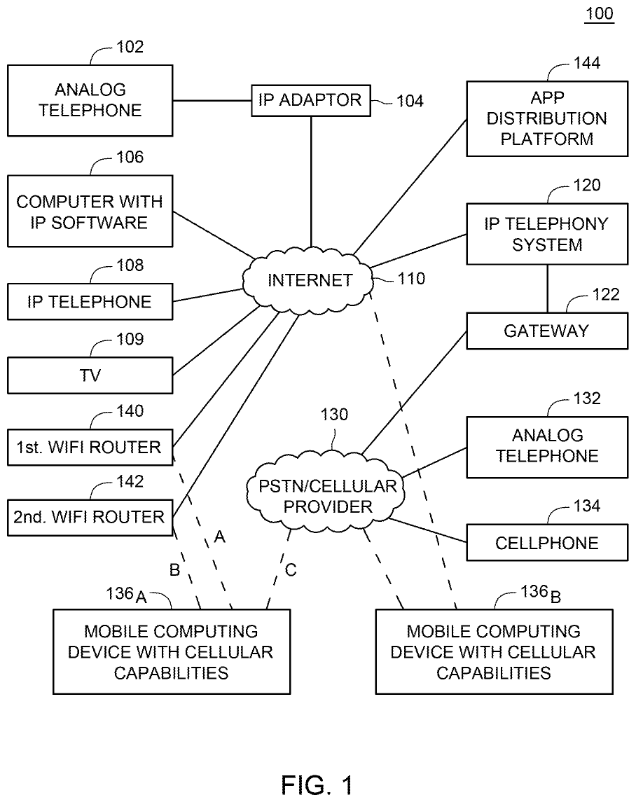

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice-based session calls, and an IP telephone that can facilitate data-based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136_{A} (e.g., a smartphone) is capable of establishing a first wireless data connection A with a first wireless access point 140, such as a WiFi or WiMax router. The first wireless access point 140 is coupled to the Internet 110. Thus, the mobile computing device 136_{A} can establish a VOIP telephone call with the IP telephony system 120 via a path through the Internet 110 and the first wireless access point 140.

FIG. 1 also illustrates that the mobile computing device 136_{A} can establish a second wireless data connection B with a second wireless access point 142 that is also coupled to the Internet 110. Further, the mobile computing device 136_{A} can establish either a third wireless data connection C via a packet-switch network provided by a cellular service provider 130 using its cellular telephone capabilities, or establish a voice-based session telephone call via a circuit-switched network provided by a cellular service provider 130. The mobile computing device 136_{A} could also establish a VoIP telephone call with the IP telephony system 120 via the second wireless connection B or the third wireless connection C.

Although not illustrated in FIG. 1, the mobile computing device 136_{A} may be capable of establishing a wireless data connection to a data network, such as the Internet 110, via alternate means. For example, the mobile computing device 136_{A} might link to some other type of wireless interface using an alternate communication protocol, such as the WIMAX standard. In the embodiments described above, a device may act as a mobile telephony device once it is configured with appropriate application software that may be downloaded from an app distribution platform 144. For example, mobile computing device 136_{A} may download a VOIP mobile app from app distribution platform 144 and install the VOIP mobile app on mobile computing device 136_{A}.

Similarly, mobile computing device with cellular capabilities 136₈ may also be coupled to internet 110 and/or cellular service provider 130. In some embodiments, mobile computing device 136₈ may be connected to internet 110 via a WIFI or WIMAX connection, and the like, and can also establish a VOIP telephone calls with the IP telephony system 120 similar to mobile computing device 136_{A}. In embodiments of the present invention, communications environment 100 may be used to establish voice based or data-based telecommunications sessions between mobile computing device 136_{A} and mobile computing device 136₈, depending on various criteria associated with each of the mobile computing devices, as will be described below in more detail.

While the embodiments discussed herein include a centralized identification server that provides recipient information, additional embodiments include a decentralized system, where the end-user devices have the ability to communicate participant information to each other directly.

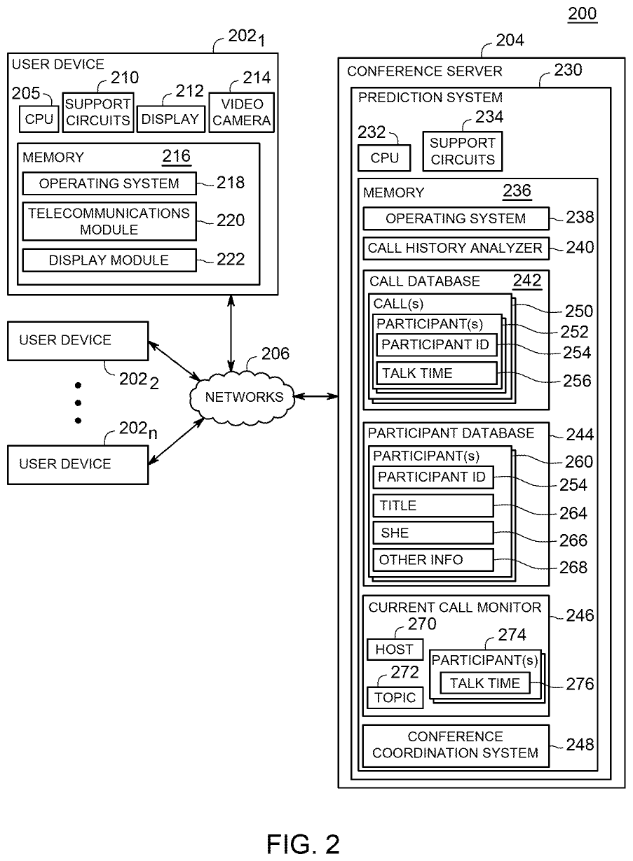

FIG. 2 depicts a block diagram of a system 200 for using predictive analysis to generate a hierarchical graphical layout during a video conferencing session, according to one or more embodiments. The system 200 comprises three or more user devices 202₁, 202₂, . . . 202ₙ (collectively referred to as user device 202) and a conference server 204 communicatively coupled via networks 206. In some embodiments, the user device 202 may be a mobile computing device (e.g., 136_{A}) associated with a user, and conference server 204 may be a server maintained and operated by IP telephony system 120 described above in FIG. 1.

Each user device 202 may comprise a Central Processing Unit (CPU) 208, support circuits 210, a display 212, a video camera 214, and a memory 216. The CPU 208 may comprise one or more commercially available microprocessors or microcontrollers that facilitate data processing and storage. The various support circuits 210 facilitate the operation of the CPU 208 and include one or more clock circuits, power supplies, cache, input/output device and circuits, and the like. The memory 216 comprises at least one of Read Only Memory (ROM), Random Access Memory (RAM), disk drive storage, optical storage, removable storage and/or the like. In some embodiments, the memory 216 comprises an operating system 218, a telecommunications module 220, and a display module 222.

The operating system (OS) 218 generally manages various computer resources (e.g., network resources, file processors, and/or the like). The operating system 218 is configured to execute operations on one or more hardware and/or software modules, such as Network Interface Cards (NICs), hard disks, virtualization layers, firewalls and/or the like. Examples of the operating system 218 may include, but are not limited to, various versions of LINUX, MAC OSX, BSD, UNIX, MICROSOFT WINDOWS, 10S, ANDROID and the like.

In some embodiments, the conference server 204 includes a prediction system 230 and a conference coordination system 248. In some embodiments, the conference coordination system 248 may be a separate entity that provides conference coordination services to the conference server 204. Conference coordination services may include sending conference invitations, collecting participant responses, gathering participant information, coordinating conference call setup among participant devices, monitoring signaling from participant devices, and the like. The prediction system 230 comprises a Central Processing Unit (CPU) 232, support circuits 234, and memory 236. The CPU 232 may comprise one or more commercially available microprocessors or microcontrollers that facilitate data processing and storage. The various support circuits 234 facilitate the operation of the CPU 232 and include one or more clock circuits, power supplies, cache, input/output circuits, and the like. The memory 236 comprises at least one of Read Only Memory (ROM), Random Access Memory (RAM), disk drive storage, optical storage, removable storage and/or the like.

In some embodiments, the memory 236 comprises an operating system 238, a call history analyzer 240, a conference call database 242, a participant database 244, a current call monitor 246 that temporarily stores in a cache, the host of the current call, the topic 272 of the conference call, the participants 274, and a total talk time 276 for each participant 274, as well as other metrics related to the current conference call. The call database 242 maintains information associated with previous calls 250, both voice calls and video conference calls. Each call 250 includes a plurality of participants 252 who participated in the call 250. Each participant 252 includes a participant identifier 254 and a talk time 256 that indicates how many minutes of the call 250 the participant 252 spoke. The participant database 244 includes a plurality of participants 260. Each participant 260 includes a participant identifier 254, a title 264 of the participant 260, the subject matter expertise 266 of the participant 260, as well as other information 268 related to the participant 260, such as a geographic location, and/or an office or branch location of the participant.

The OS 238 generally manages various computer resources (e.g., network resources, file processors, and/or the like). The operating system 238 is configured to execute operations on one or more hardware and/or software modules, such as Network Interface Cards (NICs), hard disks, virtualization layers, firewalls and/or the like. Examples of the operating system 238 may include, but are not limited to, LINUX, MAC OSX, BSD, UNIX, MICROSOFT WINDOWS, 10S, ANDROID and the like.

The networks 206 comprise one or more communication systems that connect computers by wire, cable, fiber optic and/or wireless link facilitated by various types of well-known network elements, such as hubs, switches, routers, and the like. The networks 206 may include an Internet Protocol (IP) network 110, a public switched telephone network (PSTN) 130, or other mobile communication networks listed above, and may employ various well-known protocols to communicate information amongst the network resources.

Before a conference call begins, the call history analyzer 240 predicts which participant 274 is likely to be the dominant speaker based on the total talk time 256 on previous calls 250 between the participants 274 of the current conference call. Based on the total talk time 256 from all calls 250 that include the participants 274, a calculation is performed to determine the percentage of time in the previous conference each participant spoke. For example, it may be determined that over the past communications between Participant A, Participant B, and Participant C that Participant A spoke fifty (50) percent of the time, Participant B spoke thirty (30) percent of the time, and Participant C spoke twenty (20) percent of the time. In some embodiments, the call history analyzer 240 then weighs these percentages based on who is designated the host 270 of the current call, the subject matter expertise 266 of the participant based on the topic 272 of the current call, the title 264 of the participant based on the topic 272, or other information, such as a geographic location, and/or an office or branch location of the participant, and the like. For example, if the topic 272 of the current call is product definition meeting, and Participant B is the Senior Project Director, Participant B may be weighted such that in the present meeting Participant B would be predicted to be the dominant speaker even though Participant B is typically second in total talk time. The information regarding which participant 274 is predicted to be the dominant speak, the second most dominant, and so on is sent to each user device 202.

The information regarding the dominant speaker is transmitted based on the connection type of each user device 202. For example, if the user device 202 is connected through the Internet, the information may be sent using a Transmission control Protocol/Internet Protocol (TCP/IP) connection.

The conference display module 222 of each user device 202 displays the participants on the display 212 in a hierarchy that indicates who the predicted dominant speaker is. In some embodiments, the dominant speaker is displayed having the largest percentage of area taken in the display device. In some embodiments, the dominant speaker is displayed having the uppermost position of the area in the display 212 in comparison to the remaining participants. In some embodiments, the dominant speaker is displayed having a graphically depicted border along a perimeter of the image of the dominant speaker.

The current call monitor 246 monitors which participants 274 are speaking during the call and their talk time 276. If during talk time monitoring, the talk time of the predicted dominant speaker falls below a predefined threshold of his or her historically longest talk time, the hierarchical layout is adjusted. At such time as talk time of the predicted dominant speaker falls below the predefined threshold, the current participant with a talk time that is longer than the historically longest talk time of the predicted dominant speaker is displayed more prominently than the remaining participants. The predefined threshold may be from 60-80% of the historically longest talk time of the predicted dominant speaker. The hierarchical layout is adjusted more than once every x minutes, for example no more than every two minutes.

In some embodiments, the top y places in the hierarchical layout are never adjusted. For example, if a conference call includes fifteen (15) participants and the top eight (8) participants are displayed, the top, for example five (5) participants are fixed on the display. If a non-displayed subordinate speaker increases his or her talk time above a pre-defined threshold, the non-displayed subordinate speaker may be displayed in one of the lower, non-fix positions.

In some embodiments, the system is connected to a speech-to-text engine, for example Alexa®, Siri®, or a service such as Vonage® AI that interprets the quality of what each speaker is saying. If, based on technical or business keywords detected in the speech-to-text string, general vocabulary, and the like, a subordinate speaker may be deemed to have a higher quality speech. In such embodiment, hierarchical layout of the participants is adjusted with the subordinate speaker with the higher quality speech displayed more prominently. When the current call is ended, the current call monitor 246 stores information about the call in the call database 242, including at least the talk time 276 for each participant 274.

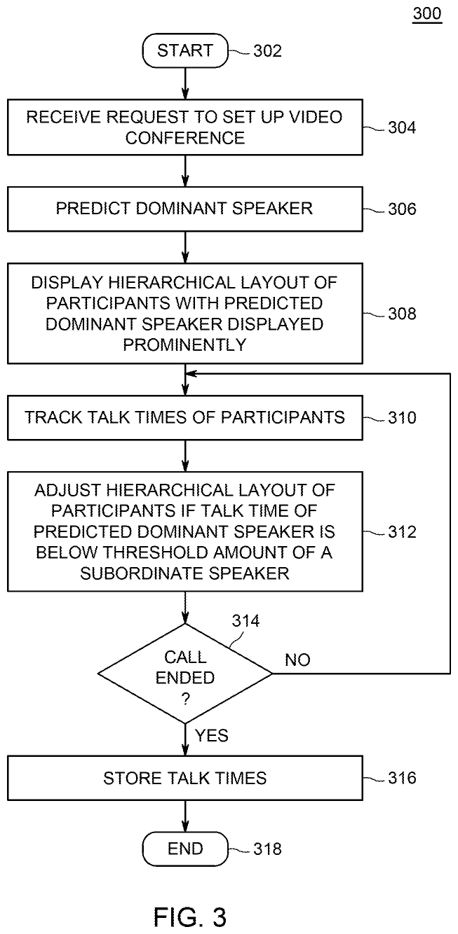

FIG. 3 depicts a flow diagram of a method 300 for using predictive analysis to generate a hierarchical layout of participants in a video conference on display devices, in accordance with one or more embodiments of the present invention. The method 300 may be performed using one or more of the modules described above with respect to FIG. 2. The method 300 starts at step 302 and proceeds to step 304.

At step 304, a request is received to set up a video conference call. The video conference call is among three or more participants. The participants may have previously been involved in voice and/or video calls prior to the present call. For example, the call may be a weekly status meeting.

At step 306, a dominant speaker of the three or more participants is predicted. In some embodiments, the participants are ranked based on who has the historically longest talk times during prior communications among the three or more participants, with the participant having the longest talk times being predicted as the dominant speaker. In some embodiments, the participants are ranked; based on one or more of call organizer, call topic, subject matter expertise as it relates to the call topic, and title of each participant, a geographic location, and/or an office or branch location of the participant. In some embodiments the participants are ranked based on who has the historically longest talk times during prior communications among the three or more participants, and then the rankings are weighted based on one or more of call organizer, call topic, subject matter expertise as it relates to the call topic, title of each participant, a geographic location, and/or an office or branch location of the participant.

At step 308, the participants are displayed in a hierarchical layout on display devices of the participants with the predicted dominant speaker displayed more prominently than the remaining three or more participants. In some embodiments, the predicted prominent speak may be displayed by taking the largest percentage of area in the display device. In some embodiments, the predicted prominent speak may be displayed in the uppermost position of the area in the display device in comparison to the remaining participants. In some embodiments, the predicted prominent speak may be displayed with a graphically depicted border along a perimeter of the image of the dominant speaker.

At step 310, the talk times of each of the three or more participants are monitored.

At step 312, the hierarchical layout of the participants is adjusted if the talk time of the predicted dominant speaker is below a threshold amount, for example, 60%-80% of talk time of a subordinate speaker. For example, if the dominant speaker is speaking only 70% of his or her historically longest time, the display is adjusted to prominently display the current participant with a talk time that is longer than the historically longest talk time of the predicted dominant speaker.

At step 314, it is determined whether the conference call has ended. If it is determined that the conference call is ended, then the method 300 proceeds to step 316, where the conference information including the participants and total talk time for each participant is stored in a database to be used in predicting future dominant speakers. However, if at step 314, it is determined that the conference call has not ended, then the method proceeds to step 310 and iterates until the conference call has ended.

The method 300 ends at step 318.

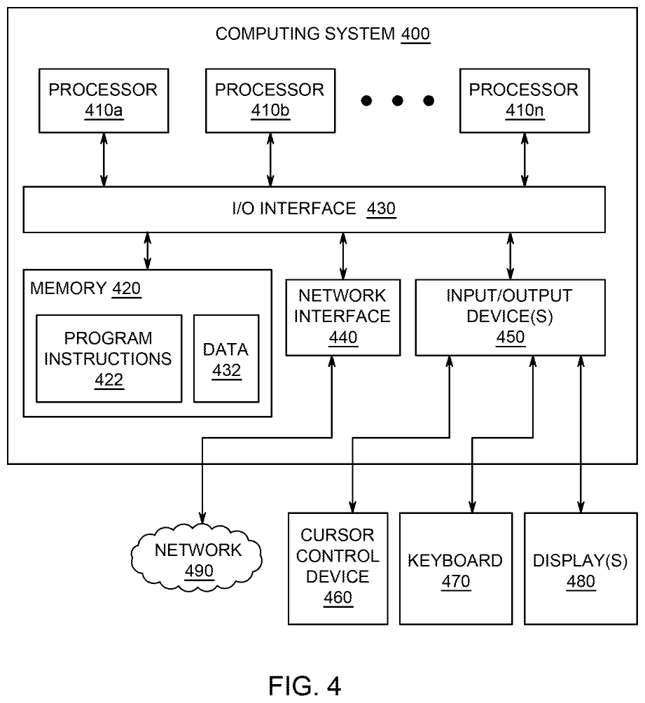

FIG. 4 is an exemplary diagram of a computer system 400 for using predictive analysis to generate a hierarchical layout of participants in a video conference on display devices in accordance to one or more embodiments of the present invention. The computer system 400 includes substantially similar structure comprising servers or electronic devices in the aforementioned embodiments.

Various embodiments of methods and system using predictive analysis to generate a hierarchical layout of participants in a video conference on display devices, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 460, such as cursor control device 460, keyboard 470, and display(s) 480. In some embodiments, the keyboard 470 may be a touchscreen input device.

In various embodiments, any of the components may be utilized by the system to authenticate a user as described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, personal computer systems, mainframe computer systems, handheld computers, workstations, network computers, application servers, storage devices, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 450 may, in some embodiments, include one or more display devices, keyboards, keypads, cameras, touchpads, touchscreens, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for using predictive analysis to generate a hierarchical layout of participants in a video conference on display devices comprising:
receiving a request to set up a video conference among three or more participants;
predicting a dominant speaker of the three or more participants in the video conference based on a call topic of the video conference and a subject matter expertise of each of the three or more participants; and
displaying a hierarchical layout of the participants on display devices of two or more remaining subordinate speakers, who are not predicted to be the dominant speaker, with the predicted dominant speaker displayed more prominently than the remaining three or more participants.

2. The method of claim 1, wherein predicting comprises:
ranking the participants based on who has the historically longest talk times during prior communications among the three or more participants.

3. The method of claim 1, wherein predicting comprises ranking the participants based on one or more of call organizer, call topic, subject matter expertise of each participant, title of each participant, a geographic location, and an office or branch location of the participant.

4. The method of claim 1, wherein predicting comprises:
ranking the participants based on who has the historically longest talk times during prior communications among the three or more participants; and
weighting the rankings of the participants based on one or more of call organizer, call topic, and title of each participant.

5. The method of claim 1, further comprising displaying to the dominant participant, a hierarchical layout of the remaining participants with a second-most dominant speaker displayed more prominently than the remaining participants.

6. The method of claim 1, further comprising:
tracking talk times of each of the three or more participants; and
storing the talk times of each of the three or more participants after the video conference has ended.

7. The method of claim 1, further comprising one of allocating additional bandwidth to the display device of the dominant participant or dividing the total bandwidth among the display devices of a predefined number of predicted top speakers.

8. The method of claim 1 wherein the prominence of the dominant speaker is in the form of one selected from the group consisting of having the largest percentage of area taken in the display device, having the uppermost position of the area in the display device in comparison to the remaining participants, having a graphically depicted border along a perimeter of the image of the dominant speaker.

9. A system for using predictive analysis to generate a hierarchical layout of participants in a video conference on display devices comprising:
a) at least one processor;
b) at least one input device; and
c) at least one storage device storing processor-executable instructions which, when executed by the at least one processor, perform a method including:
receiving a request to set up a video conference among three or more participants;
predicting a dominant speaker of the three or more participants in the video conference based on a call topic of the video conference and a subject matter expertise of each of the three or more participants; and
displaying a hierarchical layout of the participants on display devices of the two or more remaining subordinate speakers, who are not predicted to be the dominant speaker, with the predicted dominant speaker displayed more prominently than the remaining three or more participants.

10. The system of claim 9, wherein predicting comprises:
ranking the participants based on who has a historically longest talk times during prior communications among the three or more participants.

11. The system of claim 9, wherein predicting comprises ranking the participants based on one or more of call organizer, call topic, subject matter expertise of each participant, title of each participant, a geographic location, and an office or branch location of the participant.

12. The system of claim 9, wherein predicting comprises:
ranking the participants based on who has a historically longest talk times during prior communications among the three or more participants; and
weighting the rankings of the participants based on one or more of call organizer, call topic, and title of each participant.

13. The system of claim 9, further comprising displaying to the dominant participant, a hierarchical layout of the remaining participants with a second-most dominant speaker displayed more prominently than the remaining participants.

14. The system of claim 9, further comprising:
tracking talk times of each of the three or more participants; and
storing the talk times of each of the three or more participants after the video conference has ended.

15. The system of claim 9, further comprising one of allocating additional bandwidth to the display device of the predicted dominant participant or dividing the total bandwidth among the display devices of a predefined number of predicted top speakers.

16. The system of claim 9, wherein the prominence of the dominant speaker is in the form of one selected from the group consisting of having the largest percentage of area taken in the display device, having the uppermost position of the area in the display device in comparison to the remaining participants, having a graphically depicted border along a perimeter of the image of the dominant speaker.

17. A non-transitory computer readable medium for storing computer instructions that, when executed by at least one processor causes the at least one processor to perform a method for using predictive analysis to generate a hierarchical layout of participants in a video conference on display devices comprising:
receiving a request to set up a video conference among three or more participants;
predicting a dominant speaker of the three or more participants in the video conference based on a call topic of the video conference and a subject matter expertise of each of the three or more participants; and
displaying a hierarchical layout of the participants on display devices of the two or more remaining subordinate speakers, who are not predicted to be the dominant speaker, with the predicted dominant speaker displayed more prominently than the remaining three or more participants.

18. The non-transitory computer readable medium of claim 17, wherein predicting comprises:
ranking the participants based on who has a historically longest talk times during prior communications among the three or more participants; and
weighting the rankings of the participants based on one or more of call organizer, call topic, subject matter expertise of each participant, title of each participant, a geographic location, and an office or branch location of the participant.

19. The non-transitory computer readable medium of claim 17, further comprising displaying to the dominant participant, a hierarchical layout of the remaining participants with a second-most dominant speaker displayed more prominently than the remaining participants.

20. The non-transitory computer readable medium of claim 17, wherein the prominence of the dominant speaker is in the form of one selected from the group consisting of having the largest percentage of area taken in the display device, having the uppermost position of the area in the display device in comparison to the remaining participants, having a graphically depicted border along a perimeter of the image of the dominant speaker.
